(19) United States
(12) Patent Application Publication
(10) Pub. No.: US 2007/0154176 A1
(43) Pub. Date: Jul. 5, 2007

(54) Navigating recorded video using captioning, dialogue and sound effects

(76) Inventors: Albert Fitzgerald Elcock, Havertown, PA (US); John Kamienicki, Lafayette Hill, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/326,280

(22) Filed: Jan. 4, 2006

(51) Int. Cl. H04N 7/00; H04N 5/91

(52) U.S. Cl. 386/95

(57) ABSTRACT

Video navigation is provided where a video stream encoded with captioning is processed to locate captions that match a search string. Video playback is implemented from a point in the video stream near the located caption to thereby navigate to a scene in a program containing dialogue or descriptive sounds that most nearly matches the search string.

### CROSS REFERENCE TO RELATED APPLICATION

This application is related to U.S. patent application Ser. No. ______ [Motorola Docket No. BCS03870A] entitled “Navigating Recorded Video using Closed Captioning” filed concurrently herewith.

### COPYRIGHT AUTHORIZATION

A portion of the disclosure of this patent document contains material which is subject to copyright protection. The copyright owner has no objection to the facsimile reproduction by anyone of the patent document or patent disclosure, as it appears in the Patent and Trademark Office patent file or records, but otherwise reserves all copyright rights whatsoever.

### Technical Field

This disclosure is related generally to browsing and navigating video, and more particularly to navigating recorded video using captioning, dialogue and sound effects.

### BACKGROUND OF THE INVENTION

The amount of video content available to consumers is very large due in part to the use of digital storage and distribution. Whether purchased or rented on DVD (digital versatile disk) or through subscription to video content delivery services such as cable or satellite that can be stored on a digital video recorder (DVR), consumers often are looking to browse through, or navigate to specific locations in video content. For example, a user watching a movie from a DVD (or from a recording made on a DVR) may often wish to skip a specific scene. Fortunately, video in digital format gives users an ability to “jump” right to the scene of interest. This is a big advantage over traditional media such as VHS videotape which typically can only be navigated in a sequential (i.e., linear) manner using the fast-forward or rewinds controls.

Existing navigation schemes generally require indexing information to be generated that is related to the digital video. A user is presented with the index—typically through an interactive interface—to thereby navigate to a desired scene (which is sometimes called a “chapter” in a DVD) or other point in the video program.

With DVDs, the scene or chapter index is authored as part of the DVD production process. This involves designing the overall navigational structure; preparing the multimedia assets (i.e., video, audio, images); designing the graphical look; laying out the assets into tracks, streams, and chapters; designing interactive menus; linking the elements into the navigational structure; and building the final production to write to a DVD. The DVD player uses the index information to determine where the desired scene begins in the video program.

Users are generally provided with a visual display placed by the DVD player onto the television (such as a still photo of a representative video image in the chapter of interest, along perhaps with a chapter title in text) to aide the navigation process. Users can skip ahead or back to preset placeholders in the DVD using an interface such as the DVD player remote control.

With DVRs, the navigation capabilities are typically enabled during the playback process of recorded video. Here, users employ the DVR remote control to instruct the DVR to skip ahead or go back in the program using a set time interval. Some DVR systems can locate scene changes in the digital video in real time (i.e., without a scene start and end information determined ahead of time as with the DVD authoring process) to enable a user to jump through scenes in a program recorded on a DVR much like a DVD. However, no chapter index with visual cues is typically provided by the DVR.

While current digital video navigation arrangements are satisfactory in many applications, additional features and capabilities are needed to enable users to locate scenes of interest more precisely and in less time. There is often no easy way to locate these scenes, aside from fast forwarding or rewinding (i.e., fast backwards) through long sequences of video until the material of interest is found. The chapter indexing in DVDs lets the user jump to specific areas more quickly, but this is not usually sufficiently granular to meet all user needs. Additionally, if the user is uncertain about the chapter in which the scene resides, the DVD chapter index provides no additional benefit.

### BRIEF DESCRIPTION OF THE DRAWING

FIG. 1 is a simplified functional block diagram of an illustrative DVD system model;

FIG. 2 shows an illustrative DVD video cell;

FIG. 3 is a pictorial representation of an illustrative Group of Pictures (GOP) used in a DVD application;

FIG. 4 is a diagram showing an illustrative plurality of GOPs and a corresponding MPEG bitstream;

FIG. 5 is a diagram showing an illustrative format for a user data packet used to store closed captions in an MPEG bitstream;

FIG. 6 is a simplified functional block diagram of an illustrative DVD player architecture arranged to interact with a navigation engine for processing captioning;

FIG. 7 is a simplified block diagram of an illustrative navigation engine for processing captioning;

FIG. 8 is a flow chart of an illustrative method performed by a navigation engine for processing captioning;

FIG. 9 is a illustrative bitstream showing an entry into a program stream at a header that precedes a header containing a caption of interest;

FIG. 10 is an illustrative example of a graphical navigation menu using closed captioning;

FIG. 11 is an illustrative example of a graphical navigation menu using closed captioning in which nearest matches to user queries are displayed;

FIG. 12 is an illustrative example of a graphical navigation menu in which pre-selected dialogue is displayed as a navigation aide; and

FIG. 13 is a pictorial representation of a television screen shot showing a video image and a graphical navigation menu that is superimposed over the video image.

### DETAILED DESCRIPTION

Closed captioning has historically been a way for deaf and hard of hearing/hearing-impaired people to read a transcript of the audio portion of a video program, film, movie or other presentation. Others benefiting from closed captioning include people learning English as an additional language and people first learning how to read. Many studies have shown that using captioned video presentations enhances retention and comprehension levels in language and literacy education.

As the video plays, words and sound effects are expressed as text that can be turned on and off at the user's discretion so long as they have a caption decoder. In the United States, since the passage of the Television Decoder Circuitry Act of 1990 (the Act), manufacturers of most television receivers have been required to include closed captioning decoding capability. Television sets with screens 13 inches and larger, digital television receivers, and equipment such as set-top-boxes (STBs) for satellite and cable television services are covered by the Act.

The term “closed” in closed captioning means that not all viewers see the captions—only those who decode and activate them. This is distinguished from open captions, where the captions are permanently burned into the video and are visible to all viewers. As used in the remainder of the description that follows, the term “captions” refers to closed captions unless specifically stated otherwise.

Captions are further distinguished from “subtitles.” In the U.S. and Canada, subtitles assume the viewer can hear but cannot understand the language, so they only translate dialogue and some onscreen text. Captions, by contrast, aim to describe all significant audio content, as well as “non-speech information,” such as the identity of speakers and their manner of speaking. The distinction between subtitles and captions is not always made in the United Kingdom and Australia where the term “subtitles” is a general term and may often refer to captioning using Teletext.

To further clarify between subtitles and captioning, subtitling on a DVD is accomplished using a feature known as subpictures while captions are encoded into the DVD's MPEG-2 (Moving Picture Experts Group) compliant digital video stream. Each individual subtitle is rendered into a bitmap file and compressed. Scheduling information for the subtitles is written to the DVD along with the bitmaps for each subtitle. As the DVD is playing each subpicture bitmap is called up at the appropriate time and displayed over the top of the video picture.

For live programs in countries that use the analog NTSC (National Television System Committee) television system, like the U.S. and Canada, spoken words comprising the television program's soundtrack are transcribed by a reporter (i.e., like a stenographer/court reporter in a courtroom using stenotype or stenomask equipment). Alternatively, in some cases the transcript is available beforehand and captions are simply displayed during the program. For prerecorded programs (such as recorded video programs on television, videotapes and DVDs), audio is transcribed and captions are prepared, positioned, and timed in advance.

For all types of NTSC programming, captions are encoded into Line 21 of the vertical blanking interval (VBI)—a part of the TV picture that sits just above the visible portion and is usually unseen. “Encoded,” as used in the analog case here (and in the case of digital video below) means that the captions are inserted directly into the video stream itself and are hidden from view until extracted by an appropriate decoder.

Closed caption information is added to Line 21 of the VBI in either or both the odd and even fields of the NTSC television signal. Particularly with the availability of Field 2, the data delivery capacity (or “data bandwidth”) far exceeds the requirements of simple program related captioning in a single language. Therefore, the closed captioning system allows for additional “channels” of program related information to be included in the Line 21 data stream. In addition, multiple channels of non-program related information are possible.

The PAL (phase-alternating line) format used in a large part of the world is similar to the NTSC television standard but uses a different line count and frame rate, among other differences. However, like NTSC, PAL formatted video can contain closed captioning in the odd and even fields of the VBI.

The decoded captions are presented to the viewer in a variety of ways. In addition to various character formats such as upper/lower case, italic, and underline, the characters may “Pop-On” the screen, appear to “Paint-On” from left to right, or continuously “Roll-Up” from the bottom of the screen. Captions may appear in different colors as well. The way in which captions are presented, as well their channel assignment, is determined by a set of overhead control codes which are transmitted along with the alphanumeric characters which form the actual caption in the VBI.

Sometimes music or sound effects are also described using words or symbols within the caption. The Electronic Industries Alliance (EIA) defines the standard for NTSC captioning in EIA-608B. Virtually all television equipment including videocassette players and/or recorders (collectively, VCRs), DVD players, DVRs and STBs with NTSC output can output captions on line 21 of the VBI in accordance with EIA-608B.

For ATSC (Advanced Television Systems Committee) programming (i.e., digital- or high-definition television, DTV and HDTV, respectively, collectively referred to here as DTV), three data components are encoded in the video stream: two are backward compatible Line 21 captions, and the third is a set of up to 63 additional caption streams encoded in accordance with another standard—EIA-708B. DTV signals are compliant with the MPEG-2 video standard.

Closed captioning in DTV is based around a caption window (i.e., like a “window” familiar to a computer user. The caption window overlays the video and closed captioning text is arranged within it). DTV closed caption and related data is carried in three separate portions of the MPEG-2 data stream. They are the picture user data bits, the Program Mapping Table (PMT) and the Event Information Table (EIT). The caption text itself and window commands are carried in the MPEG-2 Transport Channel in the picture user data bits. A caption service directory (which shows which caption services are available) is carried in the PMT and optionally for cable, in the EIT. To ensure compatibility between analog and digital closed captioning (EIA-608B and EIA-708B, respectively), the MPEG-2 transport channel is designed to carry both formats.

The backwards compatible line 21 captions are important because some users want to receive DTV signals but display them on their NTSC television sets. Thus, DTV signals can deliver Line 21 caption data in an EIA-708B format. In other words, the data does not look like Line 21 data, but once recovered by the user's decoder, it can be converted to Line 21 caption data and inserted into Line 21 of the NTSC video signal that is sent to an analog television. Thus, line 21 captions transmitted via DTV in the EIA-708B format come out looking identical to the same captions transmitted via NTSC in the EIA-608B format. This data has all the same features and limitations of 608 data, including the speed at which it is delivered to the user's equipment.

Most current DVD players use sophisticated firmware and software (collectively referred to as control software) to fully utilize the features included in DVDs, including closed captioning. DVD video programming is organized as contiguous addressable chunks of data, known as a program stream. The program stream includes a number of packetized elementary streams including video, audio, user data, subpicture, and navigation data. In some DVDs, VBI information including Line 21 captioning is encoded as another packetized elementary stream (i.e., as a raw sampled waveform), although in this case the DVD decoder makes no attempt to use the VBI data and merely reconstructs the waveform and makes it available at the decoder output.

DVDs store video in a slightly modified version of the MPEG-2 digital format. Closed captioning support is not completely standardized in DVDs, but most DVDs include closed captioning support in a similar manner to DTV (using the picture user data bits) but also support captioning as embedded line 21 captioning from the sampled raw VBI waveform. Thus, some DVDs support closed captioning in three ways: as embedded line 21 captions that are included in the NTSC output and decoded by the television, subtitles in which a language selected is “English for the Hearing Impaired,” and as data contained in the user data of the MPEG bitstream.

DVD processing of the primary elementary streams generally utilizes MPEG schemes, with some additional restrictions. For example, DVD restricts encoded frame size and aspect ratios, and strictly sets audio sampling rates over the generic MPEG specifications. DVDs also employ the user data in the MPEG stream to carry closed captioning as noted above.

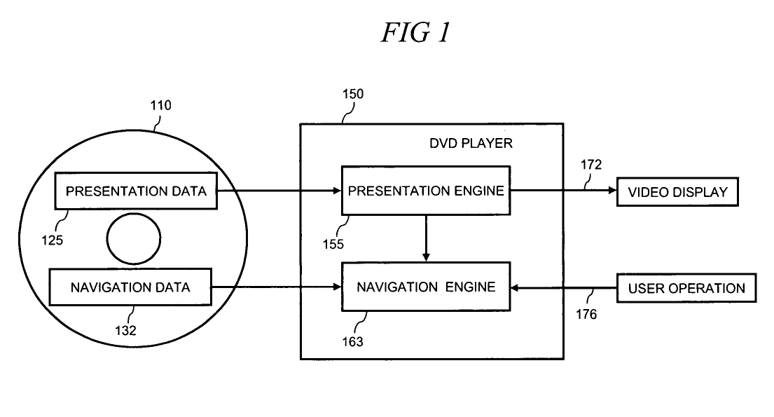

In order to play back video recorded on a DVD disc, the DVD control software includes two major components—a presentation engine and a navigation engine—that run on one or more of the DVD's processors. An arrangement is shown in FIG. 1 in which an illustrative DVD disc 110 provides presentation data 125 and navigation data 132 to a DVD player 150 that includes a presentation engine 155 and a novel navigation engine 163. It is noted that the use of a DVD player is merely illustrative as the principles and features described herein are equally applicable to other media players including, for example, a STB having a DVR, a personal computer (“PC”) with an optical drive and a software-implemented media player, and other devices having similar capabilities. All are simply referred to in the description that follows as a “DVD player.”

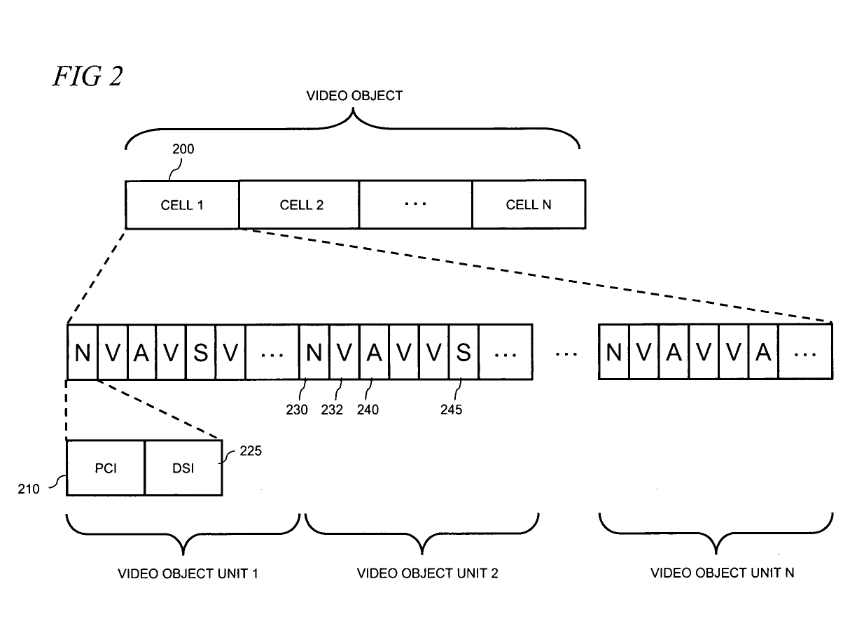

The presentation engine 155 uses the presentation data stream 125 from the DVD disc 110 to know how to render the video contained in files that are organized as part of the disc's physical data structure. The video display stream is indicated by line 172 in FIG. 1. The presentation data structure is overlaid on the DVD disc's physical data structure which defines one or more program titles. Each title includes a number of program chains (“PGC”) which are ordered collections of pointers to cells (which are described in more detail in the text accompanying FIG. 2). The physical disc data and logical presentation data structure converge at the cell level. PGCs connect cells together, define program order, and determine which cells are played by the DVD player 150.

The navigation engine 163 uses the navigation data stream 132 from the DVD disc 110 to provide a user interface, create menus, and to support random access (i.e., jumping), conditional branching and “trick play” which includes fast forward, fast backwards, and slow motion. Such user interaction is indicated by line 176 in FIG. 1. The navigation engine 163 also uses the navigation data stream 132 to control head movement in a DVD drive used to read the program stream from the DVD disc 110. The logical navigation data structure is also overlaid on the physical data structure of the DVD disc 110.

Data streams making up the packetized elementary streams can be as short as a few thousand bytes as in the case of a sub-picture stream, or as long as many gigabytes as in the case of a long movie. The data stream is stored in an individual segment on a DVD disc called a sector. Each physical sector on the DVD disc contains a total of 2064 bytes of raw data including a header area, error detection code area and user data area.

The header area contains manufacturing and encryption information. The error detection code area contains information to help the DVD player make its best guess to correct or read from the data area if its contents are damaged. The user data area holds the packetized elementary streams which makes up the DVD contents. This area is known as a logical sector or a logical block address. Logical sectors are recorded continuously on the DVD disc. A typical cell can span from one to many logical sectors.

FIG. 2 shows an illustrative DVD video cell 200. A collection of cells forms a Video Object (“VOB”) which includes the presentation data 125 (FIG. 1) and a portion of the navigation data 132 (FIG. 1). Navigation data contained in a VOB is presentation control information 210 (“PCI”) and data search information 225 (“DSI”). PCI data contains details of the timing and presentation of a program including aspect ratio, camera angles, menu highlight and selection information and so on.

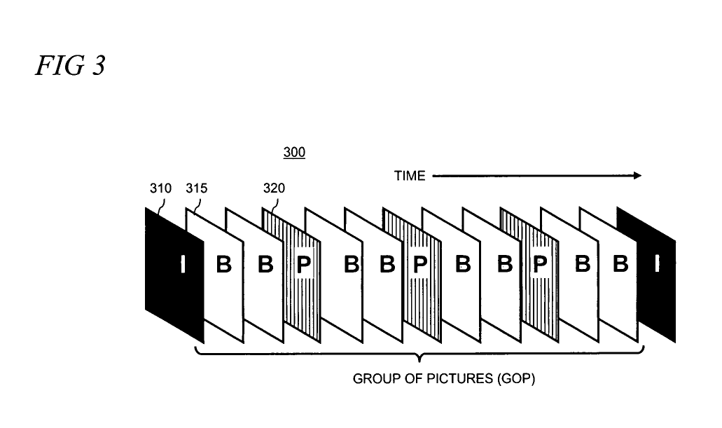

DSI data is navigation data that is spread throughout the program stream which is used for searching and seamless playback of video objects (i.e., a feature of DVD video where a program can jump from place to place on the disc without any interruption of the video. Some DVD drives are arranged so that they can read DSI data as well as program data directly from the DVD disc to further enhance seamless playback). Notably, DSI data packets include fields that identify the sector address where the first I-frame in a VOB begins (I-frames are discussed in detail in the text accompanying FIG. 3 below).

Cell 200 is a unit of playback of real-time data. Each cell is identified with a fixed cell Id number. As noted above, the PGC defines the order in which cells are played back. A title is comprised of one or more linked PGCs. In a case such as a simple movie, where one title is comprised of one PGC, the cells recorded on the disc are played back in order, and so the cell numbers and cell Id numbers will be the same. If multiple titles with different stories in a title set are defined by their own PGCs, then each PGC will call out the cells to be played for that title and the order in which they are to be played, and the cell numbers and cell Id numbers will not be the same.

In this way, DVD player 150 (FIG 1) uses PGCs and cells to allow the order and time relationship of the real-time data playback to be essentially arbitrary. This arrangement is also utilized to provide playback options such as parental level selection (i.e., for enablement of parental control options), camera angle selection, and storyline selection.

As shown in FIG. 2, cell 200 is comprised of one or more Video Object Units (VOBU). Each VOBU typically includes 0.4 seconds to 1 second of playback time. All VOBUs belonging to the same cell have the same VOBU Id (from 1 to 65,535) and cell Id (from 1 to 255). Each VOBU begins with a navigation pack 230 (N) and is followed by one or more video 232 (V), audio 240 (A), and sub-picture 245 (S) primary elementary streams which comprise the presentation data 125 (FIG. 1) in a packetized, time-division multiplexed fashion. DSI data is included in each navigation pack 230 and is renewed for each VOBU. The order of video, audio, and sub-picture primary elementary streams in a VOBU is arbitrary.

Primary elementary video streams under MPEG are compressed to reduce files sizes and consist of a sequence of sets of frames called a GOP. FIG. 3 is a pictorial representation of an illustrative MPEG-compliant GOP 300. Each group is variable in length depending on the particular video content that is represented by the GOP. While MPEG allows an unlimited number of frames in a GOP, in DVD applications a GOP is limited to 18 frames (i.e., 36 fields) for NTSC applications, and 15 frames (30 fields) for PAL applications.

All GOPs include only a single complete frame represented in full, known as an “I-frame” (indicated by reference numeral 310 in FIG. 3). An I-frame is compressed using only intraframe spatial compression to remove redundant information within that frame. Following the I-frame in the GOP sequence are temporally-compressed frames, which include only change data. Motion prediction techniques compare neighboring frames and pinpoint areas of movement, defining vectors for how each will move from one frame to the next. By recording only these vectors onto the DVD disc, the amount of data which needs to be recorded can be substantially reduced compared with recording the entire frame. The P (predictive) frames 320 shown in FIG. 3 refer only to a previous frame, while the B (bi-directional) frames 315 rely on both previous and subsequent frames. This combination of compression techniques makes MPEG scalable. Not only can the spatial compression of each I-frame be increased, but by using longer GOPs with more B and P frames, overall compression can be raised.

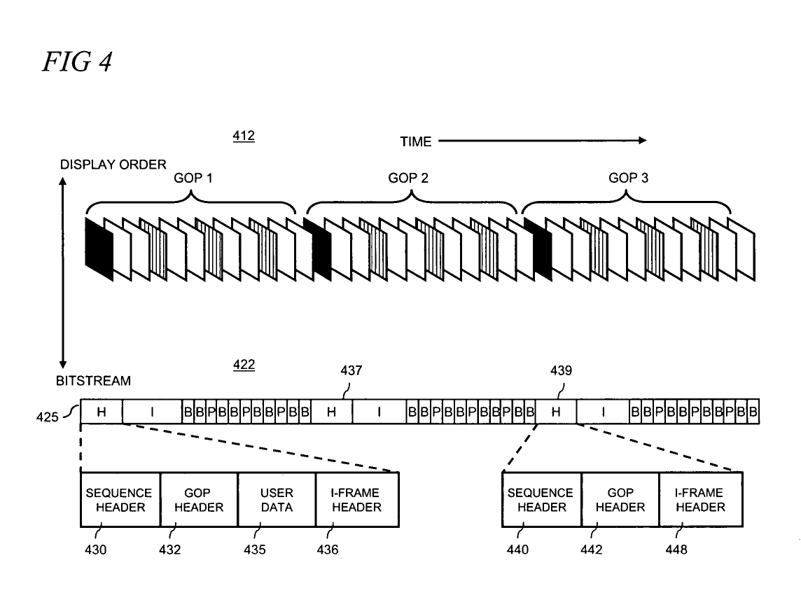

FIG. 4 is a diagram shows a plurality of illustrative GOPs 412, that are arranged in the order in which the constituent frames are rendered by the DVD player 150 (FIG. 1), and a corresponding MPEG bitstream 422. In bitstream 422, a header (H) is disposed between each GOP set, as shown. In this illustrative example, each header may differ in terms of individual packets contained in the set. Header 425 includes a sequence header 430, GOP header 432, user data packet 435, and an I-frame header 436. By contrast header 439 includes a sequence header 440, GOP header 442 and I-frame header 448, but does not contain a user data packet.

In DVDs, closed captions are stored on a GOP basis and are multiplexed in the packetized video elementary stream in a special MPEG-2 packet disposed between the GOP header packet and the I-frame header packet. Accordingly, some video objects will include user data packets when there is a corresponding caption while other video objects do not need to include the user data packet. For example, video objects in those portions of a DVD movie in which no dialogue or sound effects occurs are not required to include closed captioning user data packets.

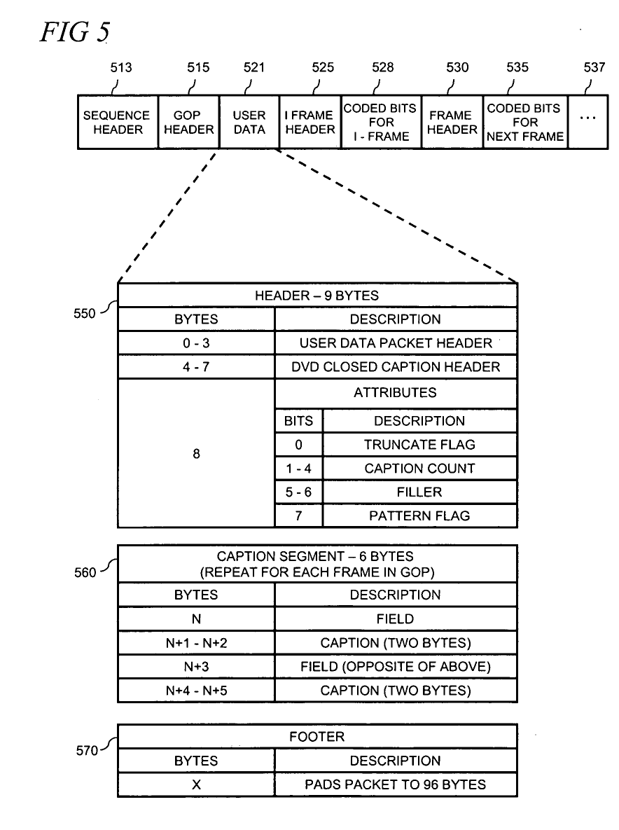

FIG. 5 is a diagram showing an illustrative format for the user data packet used to store closed captions. Shown is a set of packets making up one GOP in a DVD video object including a sequence header 513, GOP header 515, user data packet 521 and an I-frame header 525 which is followed by the coded bits comprising the I-frame and the header and coded bits for the remaining frames in the GOP sequence (as indicated by reference numerals 528, 535 and 537, respectively, in FIG. 5).

The user data packet 521, in most applications is a 96 byte packet, which includes a nine byte header 550. In the user data packet header 550 bytes 0-3 are for a user data packet header data. Bytes numbers 4-7 are used for a DVD closed caption header. Both the user data packet header and DVD closed caption header are the same for all video objects.

Byte number eight in the user data packet header 550 is used to describe various attributes of the user data packet. Bit 0 is a truncate flag which indicates whether or not to drop the last three bytes of the last caption segment when a using 15 frame limited GOP. When the truncate flag is set, then pattern flag in bit 7 used for the next closed caption must be flipped, otherwise the caption data would be lost.

Bits 1-4 in byte number eight in the user packet header 550 are used to indicate the number of closed caption segments in the packet. This is equal to the number of fames in the GOP. Bits 5 and 6 are filler and are the same for all video objects. Bit 7 is a pattern flag which is used to determine if each caption segment uses a Field 1 followed by Field 2 pattern, or Field 2 pattern followed by Field 1.

User data packet 521 further includes a 6 byte caption segment 560 which is repeated for each frame included in the GOP. For example, for a ten frame count GOP, the caption segment portion of the user data packet would be 10×6=60 bytes long. The first byte in the caption segment 560 (i.e., the nth byte as indicated in FIG. 5) is used to indicate whether a Field 1 or Field 2 caption is contained in the following field in the caption segment 560.

Bytes n+1 to n+2 are used to transmit the closed caption text and associated control code information from the field indicated in the previous byte. If there is nothing to transmit to the decoder, then this field may be filled with an arbitrary hexadecimal word to time out the frames until the next caption is read.

Although the captioning is generally encoded in the video to be timed to match exactly when words are spoken, in some instances this can be difficult, particularly when captions are short, a burst of dialogue is very fast, or scenes in the video are changing quickly. The encoding timing must also take reading-rates of viewers and control code overhead into account. All of these factors may result in some offset between the caption and the corresponding video images. Typically, the captions may lag the video image or remain on the screen longer in such situations to best accommodate these common timing constraints. The control information contained in the user data packet provides a timestamp on the caption to place the caption on the screen at the desired time taking these factors into account.

Byte n+3 is another field indicator which is always the opposite of the value indicated in nth byte (for example, if the nth byte indicates a Field 1 caption which follows in the n+1-n+2 bytes, then the n+3 byte is used to indicate Field 2). The n+4 and n+5 bytes contain closed caption text and associated control code information indicated in the previous byte.

A footer 570 completes the user data packet 521. Footer 570 is typically variable in length and is used to pad the packet out to the 96 butes length in cases when the GOP has fewer than 15 frames. In this case, a 00 byte is repeated until the packet is 96 bites long. For GOPs that include 15 frames, the truncate flag in the header is set to 1. In applications where a fixed 96-byte closed caption packet size is not utilized, the truncate flag is always 0, the pattern flag is always 1 (Field 1 followed by Field 2) and no padding is used at the end of the user data packet.

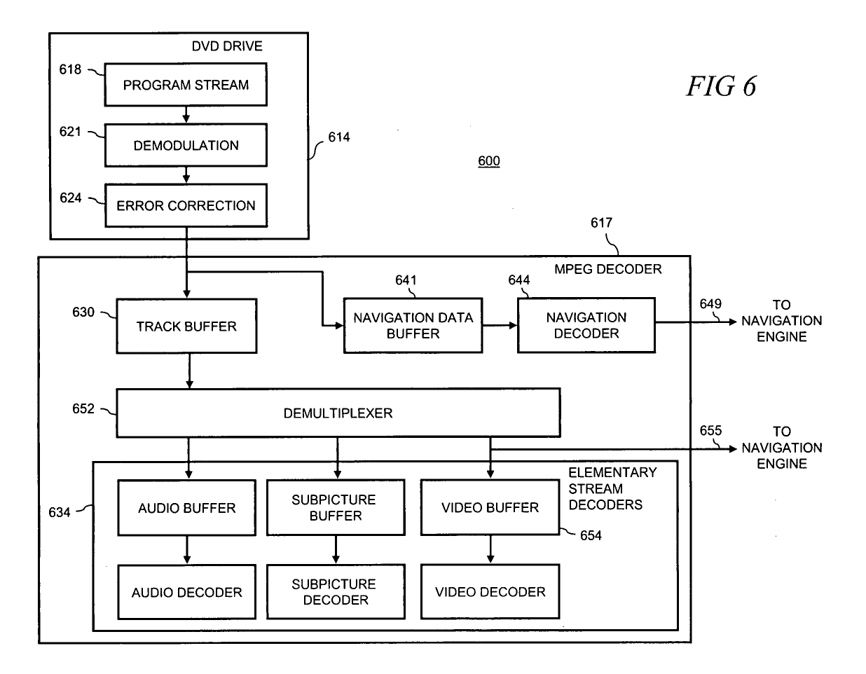

FIG. 6 is a simplified functional block diagram of an illustrative DVD player architecture 600, including a DVD drive 614 and an MPEG decoder 617, which is arranged to interact with the navigation engine 163 (FIG. 1). DVD drive 614 reads a program stream 618 from a DVD disc 10 (FIG. 1) at a constant bitrate of 26.16 Mbits/s. It is emphasized that a DVD disc is merely illustrative as other storage devices and formats may also be used depending on the requirements of a specific application. Such other devices and formats include, for example, CD (compact disc), DVD, hard disk drive, videocassette, videotape, videodisc, laserdisc, HD-DVD, BluRay, Flash RAM, Enhanced Versatile Disc, and optical holographic disc.

The program stream 618 is demodulated in functional block 621 using a conventional 8:16 demodulation scheme which locates the start and end of the physical sectors on the DVD disc 110. The output of demodulation block is a 13 Mbits/s stream. Error correction is performed in functional block 624. The output of the error correction block 624 is stream with a constant bitrate of 11.08 Mbits/s after approximately 2 Mbits/s of error correction parity data has been stripped off.

The program stream is passed to a FIFO (first in, first out) track buffer 630 in MPEG decoder 617. Navigation data (including DSI and PCI as described above in the text accompanying FIG. 2) is stripped off the program stream prior to entering the track buffer 630. This yields a maximum bitrate for the multiplexed elementary streams (including video, audio and subpictures) into the MPEG decoder 617 of 10.08 Mbits/s.

Track buffer 630 functions as a large memory between the DVD drive 614 and the individual packetized elementary stream decoders 634 so that the DVD player 150 (FIG. 1) can support variable-rate playback and seamless playback. As a result, there is a time delay between the signal being read by the DVD drive 614 and the video and audio being decoded and played. Therefore, real-time control information is divided between and stored within a navigation pack (which includes PCI and DSI packets). The MPEG decoder 617 checks and utilizes that information both before and after a cell passes through the track buffer 630.

The navigation data stripped out of the program stream is placed in a navigation data buffer 641 prior to being decoded by a navigation data decoder 644. The decoded navigation data is provided to the navigation engine 163 on line 649 to enable “look ahead” processing to enable quick location and decoding of the captions in the program stream, as described in detail below.

From the track buffer 630, the program stream is demultiplexed in demultiplexer 652 which distributes the individual packetized elementary streams to the respective elementary stream buffers and decoders 634 shown in FIG. 6. The elementary stream buffers and decoders 634 process the elementary streams to render video and subpictures on a display device coupled to the DVD player (such as a television or PC monitor) and play the associated audio.

The video stream is copied prior to entering the video stream buffer 654 and is provided to navigation engine 163 on line 655. The video stream contains the VOBs that are encoded with captions as described above in the text accompanying FIGS. 4 and 5.

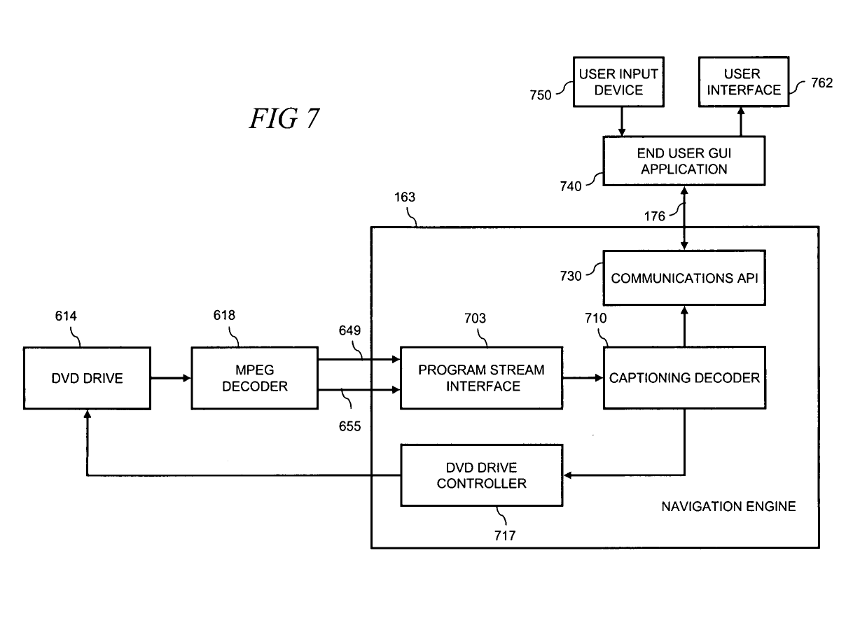

FIG. 7 is a simplified block diagram of the illustrative navigation engine 163 shown in FIG. 1 that is used for processing captioning. In most applications, the navigation engine 163 is implemented as control software in the DVD player 150 (FIG. 1). In alternative applications, navigation engine 163 is implemented in hardware such as an application specific integrated circuit.

A program stream interface 703 receives the program stream including the navigation data stream on line 649 and the video stream 655 from the MPEG decoder 617. A captioning decoder 710 is coupled to the program stream interface 703 and is arranged to decode the captions encoded in the video stream. Captioning decoder 710 is further arranged to process DSI data from the navigation data stream to optimize head movement in the DVD drive 614. That is, the DSI data is utilized to control the DVD drive 614 to efficiently and quickly locate the I-frames in the program stream. This arrangement advantageously enables captions to be located and decoded quickly by an optimized methodology that removes P-frame and B-frame processing in order to provide DVD navigation using dialogue in a “real time” manner. That is, the speed at which captions containing dialogue of interest are located is sufficiently fast to provide a navigation aide that is as convenient and quick to use as pre-authored chapter index navigation.

Accordingly, a DVD drive controller 717 is coupled to the captioning decoder 710. DVD drive controller 717 controls the DVD drive 614 so that drive head movement (and associated reading of data from the DVD disc 110 in FIG. 1) is tightly coupled to the processing performed in captioning decoder 710.

A communications API 730 (application programming interface) is included in navigation engine 163 and coupled to captioning decoder 710, as shown. The communications API 730 is arranged to communicate with an end-user graphical user interface (“GUI”) application 740 over line 176. In some settings, the end-user GUI application is a standalone application that runs on one or more processors in the DVD player 150. The end-user GUI application 740 may be combined with other typical user controls and interfaces that are used with a DVD player. Alternatively, the end-user GUI application 740 may be embedded in the navigation engine 163.

A user input device 750 comprising, for example, an IR (infrared) remote control, a keyboard, or a combination of IR remote control and keyboard is coupled to communicate with the end-user GUI application 740. User input device 750 enables a user to provide inputs to the navigation engine 163 through the end-user GUI application 740 and communications API 730. In alternative arrangements, user input device 750 is configured with voice recognition capabilities so that a user may provide input using voice commands.

A user interface 762, including a navigation menu, is further coupled to communicate with the end-user GUI application 740. The navigation menu is preferably a graphical interface in most applications whereby choices and prompts for user inputs are provided on a display or screen such as a television that is coupled to a DVD player or STB, or a monitor used with a PC. It is contemplated that user input device 750 and user interface 762 may also be incorporated into a single, unitary device in which the display device for the graphical navigation menu either replaces or supplements the television or monitor.

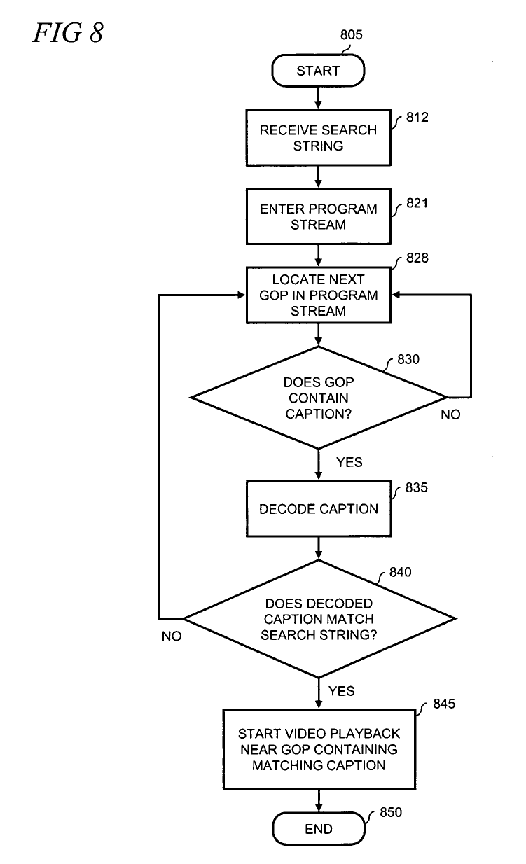

FIG. 8 is a flow chart for an illustrative method that is performed, for example, by the navigation engine 163 shown in FIGS. 1 and 7. The process starts at block 805. A query from a user is received at block 812. The query, in this example, is a search from a user which contains phrases, tag lines or keywords that the user anticipates are contained as dialogue or sound descriptions in a program such as a movie video on a DVD. The user searching is facilitated with the end-user GUI application 740 (FIG. 7) which includes a graphic navigation menu as noted above.

The ability to search captioning in the video may be useful for a variety of reasons. For example, navigating a video by dialogue or sound descriptions provides a novel and interesting alternative to existing chapter indexing or linear searching using fast forward or fast backward. In addition, users frequently watch video programs and movies over several viewing sessions. Dialogue may serve as a mental “bookmark” which helps a user recall a particular scene in the video. By searching the captioning for the dialogue of interest and locating the corresponding scene, the user may conveniently begin viewing where he or she left off.

At block 821 in FIG. 8 the program stream read from the DVD drive 614 (FIGS. 6 and 7) is entered at some point. In most applications, the program stream is entered at the start of the first title on the DVD (i.e., at the beginning or the program or movie that is encoded on the DVD disc).

At block 828, the DSI data is used to move the read head in the DVD drive 614 to read the first VOBU in the program stream. The VOBU is checked for captioning contained in the user data packet 521 (FIG. 5) at block 830. If captioning is present, then the caption is decoded as indicated in block 835. Otherwise, the DVD drive moves to the next VOBU in the program stream and the captioning detection process is repeated. This loop is repeated until the next caption is located.

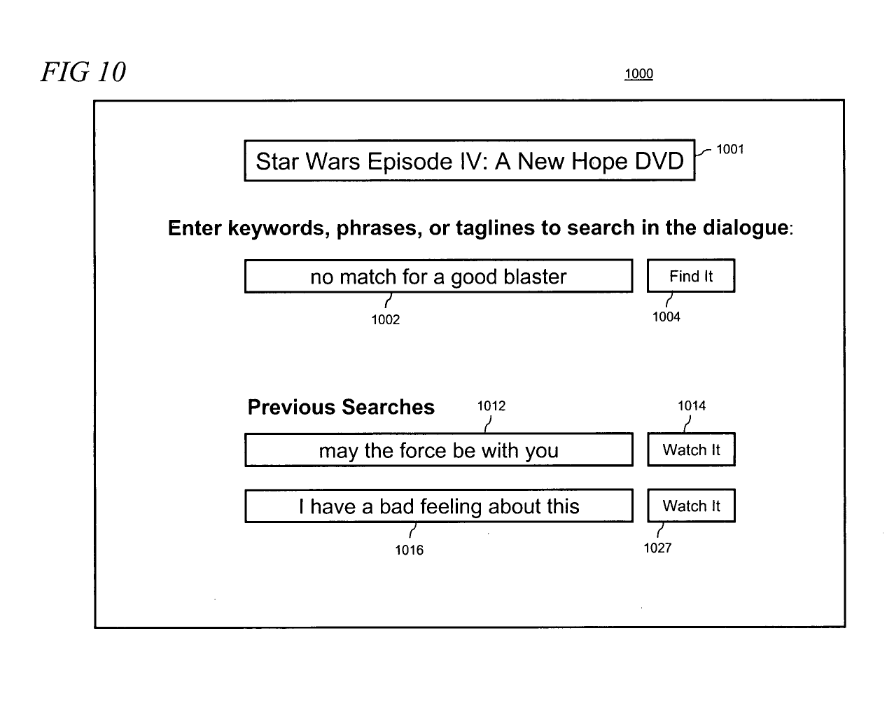

At block 840 the decoded caption is compared against the search string forming the user query to determine the occurrence of a match. Optionally, the method may be varied to employ a comparison algorithm that enables captions to be located that most nearly match the user's query in instances when an exact match cannot be located This optional aspect is described in the text accompanying FIG. 10.

If the decoded caption does not match user query, then control is passed back to block 828 and the method in blocks through 840 continues (typically in sequential fashion from the beginning of a title and working forward in time from VOBU to VOBU in the program stream) until a caption match is located. Once a decoded caption is located that matches the user query, then control is passed to block 845.

The following dialogue in the movie video “Star Wars” is provided below to illustrate the portion of the method included in block 845:

Line 1: “Hokey religions and ancient weapons are no match for a good blaster at your side, kid.”

Line 2: “You don't believe in the Force, do you?”

Line 3: “Kid, I've flown from one side of this galaxy to the other. I've seen a lot of strange stuff, but I've never seen anything to make me believe there's one all-powerful force controlling everything. There's no mystical energy field that controls my destiny.”

© 1977, 1997 & 2000 Lucasfilm Ltd.

Line 1 is spoken by the character approximately 60 minutes and 49 seconds (60:49) from the beginning of the movie video; Line 2 occurs at 60:54; and Line 3 occurs at 60:57. Accordingly, the timestamp in a user data packet containing a caption corresponding to Line 1 indicates that the caption should be placed on screen starting around 60:49 (and so on for Lines 2 and 3).

At block 845, the DVD drive controller 717 (FIG. 7) sets playback of video in the program to begin at a point near to the GOP that contains the matching caption. For example, if the user's query contained the phrase “no match for a good blaster” then the playback of the video should start near the point in the video that Line 1 is spoken.

In order to ensure seamless playback from an arbitrary point in a program stream, the entry into the stream must be at a header “H” that precedes an I-frame. Otherwise, decoding errors can occur because the P-frames and B-frames need to have a reference I-frame in the decoder buffer to be properly decoded.

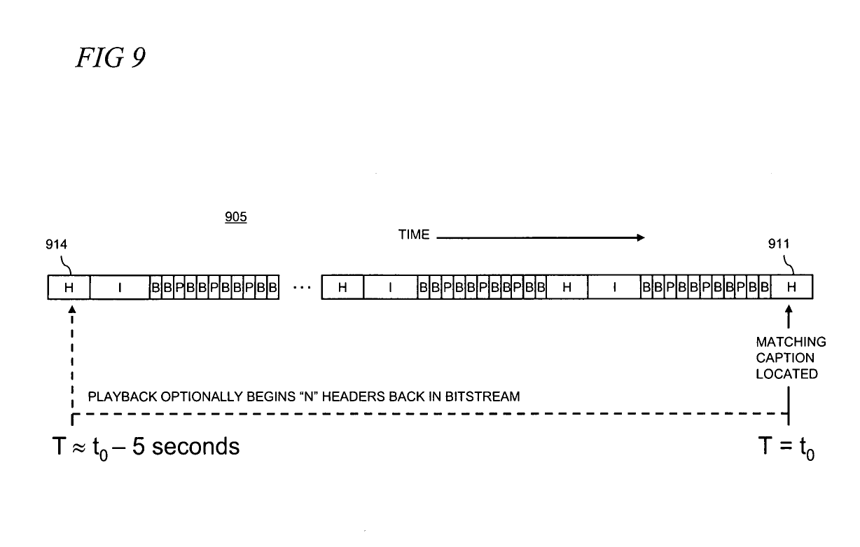

FIG. 9 shows an illustrative bitstream in which a caption matching the user's query is located in a user data packet that is included in header 911. In some applications, playback of the program begins at from a header in the program stream that includes the matching caption. Optionally, to accommodate any offset between the caption encoding and the occurrence of the video image containing the captioned dialogue (as noted above), playback is set to start further back in time in the program stream. For example, an arbitrary interval (for example five seconds) can be subtracted from the caption start time to ensure that the scene from the movie video containing the phrase in the user's query is located and played in its entirety, or to provide context to the scene of interest.

Using the Line 1 example above, the playback start time would be 60:49 minus 5 seconds equaling 60:44. Accordingly, some integer number N of headers is counted backwards from header 911 so that approximately 5 seconds of video is played prior to the processing of header 911. In that way, the program stream is entered near the point in the video which is 60 minutes and 44 seconds from the beginning. The video playback start point is shown as header 914 in FIG. 9 when utilizing this optional time offset.

Referring back to FIG. 8, In block 845 the DVD driver controller 717 (FIG. 7) operates the DVD drive 614 responsively to the caption located in the program stream that matches the user query. Thus, the scene containing the Line 1 dialogue “Hokey religions and ancient weapons are no match for a good blaster at your side, kid” is decoded and played. The method ends at block 850.

The illustrative method thereby advantageously enables video navigation by dialogue (or other information contained in the captioning data such as description of sounds occurring in the video) to supplement current navigation schemes such as chapter indexing It is noted that the caption location and search methodologies shown and described above are arranged so that they may be performed much more quickly than current linear navigation methods (i.e., fast forward and fast backward). In addition, while the methods are designed to minimize processing overhead and efficiently manage drive head motion, even further increases in caption location speed may be realized through the use of players with faster drives and more powerful processors.

An illustrative example of a graphical navigation menu that is displayed on the user interface 762 (FIG. 7) is shown in FIG. 10. In this example, the movie video source is a DVD as indicated by the title field 1001. A user input field 1002 is arranged to accept alphanumeric input from the user which forms the user query. Button 1004 labeled “Find it” is arranged to initiate the search of the VOBUs in the program stream (as shown in FIG. 8 and described in the accompanying text) once the query is entered in input field 1002. As shown in FIG. 10, other fields 1012 and 1016 are populated with previous queries from the user. Such previous user searches would have already initiated searches of the captions in the video's program stream to thereby locate the scene in the video movie containing the dialogue that matches (or most nearly matches) the user's query. Thus, buttons 1014 and 1027 are labeled “Watch it” and are arranged to initiate an operation of the DVD drive 614 (FIG. 6) responsively to captioning decoder 710 (FIG. 7) which locates the scene corresponding to the previous user queries 1012 and 1016.

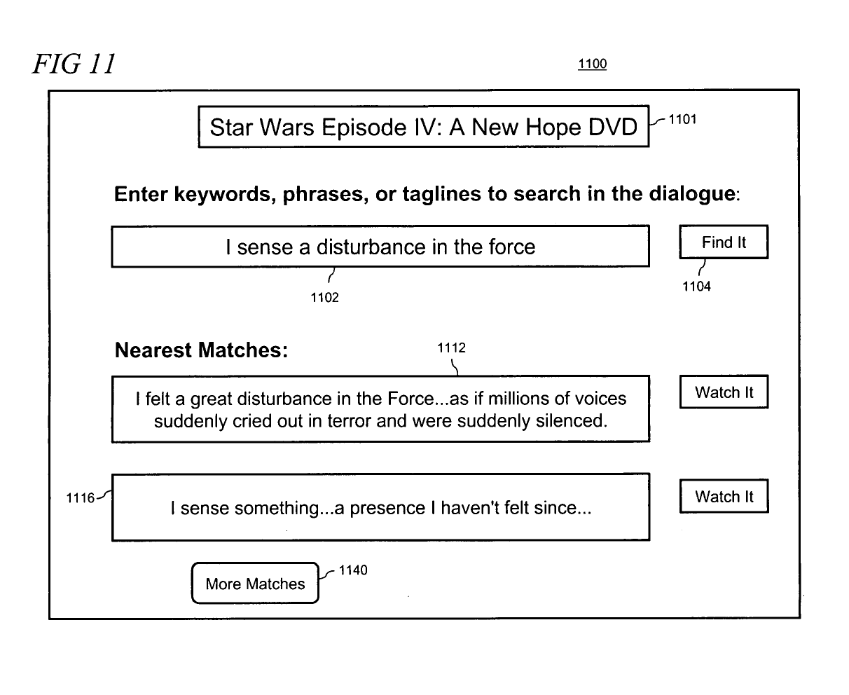

FIG. 11 is an illustrative example of a graphical navigation menu 1100 using closed captioning in which nearest matches to user queries are displayed. As with FIG. 10, the movie video source in this example is a DVD, as indicated by the title field 1101. A user input field 1102 is arranged to accept alphanumeric input from the user which forms the user query. Button 1104 labeled “Find it” is arranged to initiate the search of the captioning index once the query is entered in input field 1102.

As shown, the user input is the phrase “I sense a disturbance in the force.” Although this exact phrase is not contained in the movie dialogue, several alternatives which most nearly match the user query are located in the captioning index and displayed on the graphical navigation menu 1100. These nearly-matching alternatives are shown in fields 1112 and 1116. Optionally, graphical navigation menu 1100 is arranged to show one or more thumbnails (i.e., a reduced-size still shot or motion-video) of video that correspond to the fields 1112 and 1116. Such optional thumbnails are not shown in FIG. 4.

A variety of conventional text-based string search algorithms may be used to implement the search of the captioning contained in a video depending on the specific requirements of an application of video navigation using closed captioning. For example, fast results are obtained when the captioning text is preprocessed to create an index (e.g., a tree or an array) with which a binary search algorithm can quickly locate matching patterns.

Known correlation techniques are optionally utilized to locate captions that most nearly match a user query when an exact match is unavailable. Accordingly, a caption is more highly correlated to the user query (and thus more closely matching) as the frequency with which search terms occur in the caption increases. Typically, common words such as “a”, “the”, “for” and the like, punctuation and capitalization are not counted when determining the closeness of a match.

As shown in FIG. 11, the caption in field 1112 has three words (not counting common words) that match words in the search string in field 1116. The caption in field 1116 has two words that match. Accordingly, the caption contained in field 1112 in FIG. 11 is a better match to the search string contained in field 1102 than the caption contained in field 1116. Close matching captions, in this illustrative example, are rank ordered in the graphical navigation menu 1100 so that captions that are more highly correlated to the search string are displayed first. In some instances, more matches might be located than may be conveniently displayed on a single graphical navigation menu screen. This may occur, for example, when the search string contains a relatively small number of keywords or a particularly thematic word (such as the word “force” in this illustrative example) is selected. Button 1140 on graphical navigation menu may be pressed by the user to display more matches to the search string when they are available.

Other common text-based search techniques may be implemented as needed by a specific application of closed-captioning-based video navigation. For example, various alternative search features may be implemented including: a) compensation for misspelled words in the search string; b) searching for singular and plural variations of words in the search string; c) “sound-alike” searching where spelling variations—particularly for names—are taken into account; and, d) “fuzzy” searching where searches are conducted for variations in words or phrases in the search string. For example, using fuzzy searching, the search query “coming fast” will return two captions: “They're coming in too fast” and, “Hurry Luke, they're coming much faster this time” where each caption corresponds to a different scene in the movie to which a user may navigate. © 1977, 1997 & 2000 Lucasfilm Ltd.

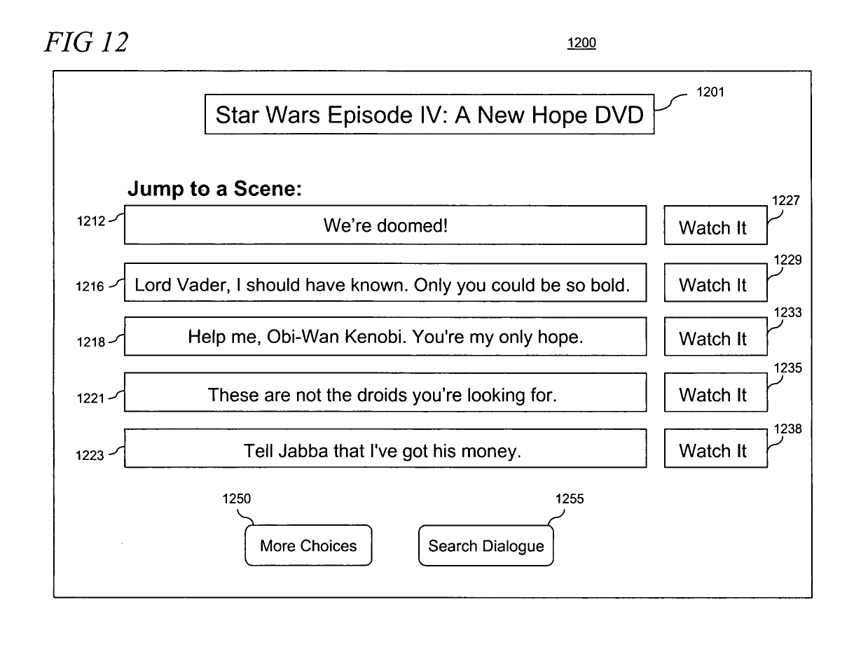

FIG. 12 is an illustrative example of an optionally utilized graphical navigation menu 1200 that displays dialogue such as well known movie tag lines or phrases that are pre-selected, for example, by a DVD author like a movie production studio. In this example, the user may jump to a number of different scenes using dialogue as a navigation aide. The movie video source is a DVD as indicated by the title field 1201. Five different scenes containing the dialogue shown in fields, 1212, 1216, 1218, 1221 and 1223 are available to the user. The pre-selected dialogue and scenes are presented to the user who may jump to a desired scene by pressing a corresponding buttons 1227, 1229, 1233, 1235 and 1238, respectively, on graphical video navigation menu 1200. Additional scenes and dialogue are available for user selection by pressing button 1250. The user may also go the search screens shown in FIGS. 10 and 11 by pressing button 1255. Optionally, one or more thumbnails of scenes containing the pre-selected dialogue are displayed in graphical navigation menu 1200 to aid a user in navigating to desired content. Such optional thumbnails are not shown in FIG. 12.

The present arrangement advantageously enables additional video navigation features to be conveniently provided on a DVD. Graphical navigation menus like those shown in FIGS. 10-12 are encoded into the navigation data stream. A user may access a graphical navigation menu using the same remote control that is used to operate the DVD player. By using the remote control, the user brings up the graphical navigation menu whenever desired to navigate backwards or forwards in the video program. As described above, the user chooses from pre-selected dialogue and scenes to jump to, or enters a search string to navigate to a desired scene which contains the dialogue of interest.

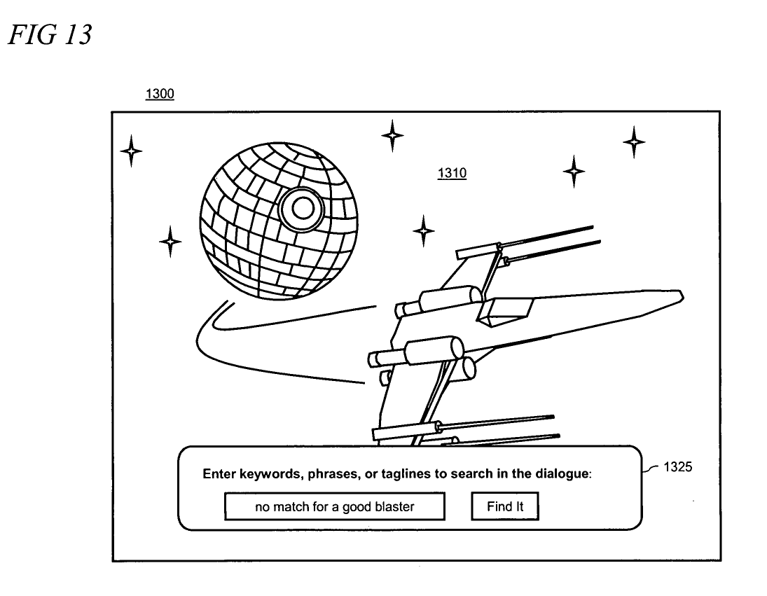

FIG. 13 is a pictorial representation of a television screen shot 1300 showing a video image 1310 and a graphical navigation menu 1325 that is superimposed over the video image 1310. In this illustrative example, the video 1310 runs in normal time in the background. Navigation engine 163 (FIGS. 1 and 7), as described above, displays the graphical navigation menu 1325 as a separate “window” that enables a user to simultaneously watch the video and search captioning contained therein.

Each of the various processes shown in the figures and described in the accompanying text may be implemented in a general, multi-purpose or single purpose processor. Such a processor will execute instructions, either at the assembly, compiled or machine-level, to perform that process. Those instructions can be written by one of ordinary skill in the art following the description herein and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

1. A method for navigating video, comprising:
decoding at least a portion of one or more captions in a series of captions encoded in the video;
comparing the decoded caption portion against a search string; and
repeating the decoding and comparing until locating a portion of a caption in the video that most nearly matches the search string.

2. The method of claim 1 where the search string is included in a request from a user to navigate to a scene in the video.

3. The method of claim 1 further including playing the video from a point in the video near the located caption to thereby navigate to a scene in the video containing dialogue or descriptive sounds that most nearly matches the search string.

4. The method of claim 1 where the decoding is performed sequentially on the series of captions.

5. A navigation engine in a video player that includes a media drive, the navigation engine comprising:
a media drive controller for controlling the media drive;
a program stream interface for receiving program stream data from media read by the media drive; and
a captioning decoder for decoding captioning encoded in the program stream data, the captioning decoder arranged to communicate with the media drive controller so that the media drive selectively supplies program stream data to the program stream interface.

6. The navigation engine of claim 5 where the channel data includes a plurality of DSI packets, each DSI packet including a field a sector address where a first reference frame in a video object begins.

7. The navigation engine of claim 6 where the video object is a Group of Pictures complying with MPEG.

8. The navigation engine of claim 5 where the selective supply of program stream data excludes P frames and B frames.

9. The navigation engine of claim 5 where the selective supply of program stream data excludes reference frames that do not contain captioning.

10. The navigation engine of claim 5 where the selective supply of program stream data excludes GOPs that do not contain captioning.

11. The navigation engine of claim 5 where the captioning comprises closed captioning.

12. The navigation engine of claim 5 where the captioning comprises captioning transported in user data bits of a digital bitstream.

13. The navigation engine of claim 5 further including a communications API for receiving the search string from a user.

14. The navigation engine of claim 13 where the communications API is arranged for sending data that is presentable by a GUI object as an interactive navigation menu.

15. The navigation engine of claim 14 where the communications API is arranged to receive user inputs responsive to the interactive navigation menu.

16. The navigation engine of claim 15 where the user inputs include alphanumeric user inputs to the interactive navigation menu.

17. The navigation engine of claim 16 where the alphanumeric user input is selected from one of a phrase, keyword, tagline and dialogue.

18. A computer-readable medium encoded with video content readable by a video player, which when executed by one or more processors disposed in the video player, performs a method comprising:
providing a user interface for navigating the video content by dialogue or sound effects;
receiving a search string from a user through the user interface; and
providing navigation data to enable the video player to locate video content that includes dialogue or sound effects that most nearly matches the search string.

19. The computer-readable medium of claim 18 further including instructions which, when executed by the one or more processors, commands the video player to play video starting from a sequence header that precedes a GOP containing the located video content.

20. The computer-readable medium of claim 18 where the user interface is arranged to enable a user to select from one or more scenes in the video stream using dialogue from the one or more scenes as the selection criteria.
